(19) United States
(12) Patent Application Publication
(10) Pub. No.: US 2026/0270719 A1
(43) Pub. Date: Sep. 10, 2026

(54) METHODS FOR LIFE CYCLE MANAGEMENT (LCM) BASED ON DATASET SIMILARITY

(71) Applicant: InterDigital Patent Holdings, Inc., Wilmington, DE (US)

(72) Inventors: Akshay Malhotra, San Jose, CA (US); Yugeswar Deenoo Narayanan Thangaraj, Chalfont, PA (US); Anouar Yatribi, Greater London (GB); Mihaela Beluri, Jericho, NY (US); Aditya Sant, San Jose, CA (US); Shahab Hamidi-Rad, Sunnyvale, CA (US)

(73) Assignee: InterDigital Patent Holdings, Inc., Wilmington, DE (US)

(21) Appl. No.: 19/070,042

(22) Filed: Mar. 4, 2025

(51) Int. Cl. H04W 24/02

(52) U.S. Cl. CPC H04W 24/02

(57) ABSTRACT

A WTRU may receive configuration information that includes dataset similarity configuration information. The WTRU may be configured with a plurality of artificial intelligence machine learning (AIML) models and/or training data set(s) associated with each AIML model of the plurality of AIML models. The WTRU may generate a data sample set based on the dataset similarity configuration information. The WTRU may determine a first dataset similarity value for a (e.g., first) AIML model. The first dataset similarity value may be determined based on the dataset similarity configuration information, the data sample set, and training data set(s) associated with the (e.g., first) AIML model. The dataset similarity value for the training data set may indicate a similarity between the training data set associated with the (e.g., first) AIML model and the data sample set. The WTRU may send an indication that indicates the first dataset similarity value and/or a preferred AIML model.

### BACKGROUND

Artificial intelligence (AI) may be referred to as the behavior exhibited by machines. Such behave may, for example, mimic cognitive functions to sense, reason, adapt, and/or act. The terms AI, machine learning (ML), deep learning (DL), and/or deep neural network (DNN) may be used interchangeably.

### SUMMARY

A wireless transmit/receive unit (WTRU) may measure and/or report similarity metric(s) between sets of pre-configured training data sets and an inference dataset, corresponding to the set of data samples being observed and/or received at the time of operation. The WTRU and/or base station (BS) may utilize these similarity and/or distance values for performance monitoring, model switching, out-of distribution (OOD) detection, associate ID management, etc.

A WTRU may receive configuration information. The configuration may include dataset similarity configuration information. The WTRU may be configured with a plurality of artificial intelligence machine learning (AIML) models and/or training data set associated with each AIML model of the plurality of AIML models. The WTRU may generate a data sample set based on the dataset similarity configuration information. The WTRU may determine a first dataset similarity value for a first AIML model of the plurality of AIML models. The first dataset similarity value may be determined based on the dataset similarity configuration information, the data sample set, and training data set associated with the first AIML model. The dataset similarity value for the training data set may indicate a similarity between the training data set associated with the first AIML model and the data sample set. The WTRU may send an indication to a base station. The indication may indicate the first dataset similarity value and/or a preferred AIML model of the plurality of AIML models.

The WTRU may generate a data sample set based on the dataset similarity configuration information and/or based on or for the AIML model.

The WTRU may determine that the first dataset similarity value for the first AIML model is below a threshold. The WTRU may determine a second dataset similarity value for a second AIML model of the plurality of AIML models based on the dataset similarity configuration information, the data sample set, and/or the training data set associated with the second AIML model. The WTRU may determine that the second dataset similarity value is above the threshold. The preferred AIML model indicated by the indication is the second AIML model.

The WTRU may determine that the first dataset similarity value for the first AIML model is below a threshold. The WTRU may determine a second dataset similarity value for a second AIML model of the plurality of AIML models based on the dataset similarity configuration information, the data sample set, and/or the training data set associated with the second AIML model. The WTRU may determine that the second dataset similarity value is above the threshold. The WTRU may activate the second AIML model based on the second dataset similarity value being above the threshold.

The WTRU may determine that the first dataset similarity value for the first AIML model is blow a threshold. The WTRU may determine a second dataset similarity value for a second AIML model of the plurality of AIML models based on the dataset similarity configuration information, the data sample set, and/or the training data set associated with the second AIML model. The WTRU may determine that the second dataset similarity value is below a second threshold. The WTRU may fallback to other (e.g., legacy) operation and/or send a request to the base station for an additional (e.g., AIML) model.

The WTRU may compare the data sample set to the training data set of the first AIML model to determine the first dataset similarity value.

The dataset similarity configuration may include one or more of: a similarity metric, one or more thresholds, and/or performance prediction curves. The WTRU may determine the first dataset similarity value based on the similarity metric, the one or more thresholds, and/or the performance prediction curves.

The WTRU may determine the first similarity metric using one or more of a geometric-based distance, a statistical-based distance, and/or a manifold-based metric The geometric-based distance may include one or more of a pairwise Euclidean-based metric, a centroid wise Euclidean-based metric, a cluster wise Euclidean-based metric, and/or a cosine-based metric. The statistical-based distance may include one or more of a kullback-leiber divergence-based metric, a Jensen Shannon-based metric, a Wasserstein-based metric, a Hellinger-based metric, and/or a total variation-based metric. The manifold metric may include one or more of a Grassmann-based metric and/or a chordal-based metric.

The dataset similarity configuration information may include a lower dimensional space value. The WTRU may use a dimensionality reduction method to determine, based on the lower dimensional space value, a reduced dataset dimensionality of the data sample set and/or a reduced dimensionality of the training data set associated with the first AIML model. The first dataset similarity value may be determined based on the reduced dataset dimensionality of the data sample set and/or the reduced dimensionality of the training data set associated with the first AIML model.

The dataset similarity configuration information may include an indication that indicates a minimum number of data samples and/or a period of time. The WTRU may generate the data sample set based on the minimum number of data samples and/or the period of time.

When the first dataset similarity value is less than a threshold, the WTRU may send a message to a base station. The message may include an indication that indicates a request for one or more additional AIML models and/or corresponding datasets.

The WTRU may be configured to use the first AIML model to perform one or more of: channel state information (CSI) compression, CSI prediction, channel estimation, and/or beam management.

A WTRU may receive configuration information. The configuration information may include dataset similarity configuration information. The WTRU may be configured with a plurality of artificial intelligence machine learning (AIML) models and/or training information (e.g., one or more training data sets) associated with each AIML model of the plurality of AIML models. The WTRU may generate a data sample set associated with a first AIML model of the plurality of AIML models. The WTRU may determine a dataset similarity value for the first AIML model based on the dataset similarity configuration information, the training information associated with the first AIML model, and/or the data sample set. The dataset similarity value may indicate a similarity between the training information (e.g., one or more training data sets) associated with each AIML model and the data sample set for the activated AIML model. The WTRU send an indication to a base station. The indication may indicate the dataset similarity value and a preferred AIML model.

A WTRU may receive configuration information. The configuration information may include dataset similarity configuration information. The WTRU may be configured with a plurality of training data sets and/or an AIML model. The WTRU may generate a data sample set associated with the AIML model. The WTRU may determine a dataset similarity value for the AIML model based on the dataset similarity configuration information, the plurality of training data sets, and/or the data sample set. The dataset similarity value may indicate a similarity between the plurality of training data sets associated with the AIML model and the data sample set. The WTRU may send an indication to a base station. The indication may indicate the dataset similarity value and/or a preferred AIML model.

A WTRU may receive configuration information. The configuration information may include dataset similarity configuration information. The WTRU may be configured with a plurality of training data sets and/or a plurality of AIML models. The WTRU may generate a data sample set associated with the plurality of AIML models. The WTRU may determine a dataset similarity value for each AIML model based on the dataset similarity configuration information, the plurality of training data sets, and/or the data sample set. The dataset similarity value may indicate a similarity between the plurality of training data sets associated with each AIML model of the plurality of AIML models and the data sample set. The WTRU may send an indication to a base station. The indication may indicate the dataset similarity value and/or a preferred AIML model (e.g., of the plurality of AIML models).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example of a performance prediction curve.

### DETAILED DESCRIPTION

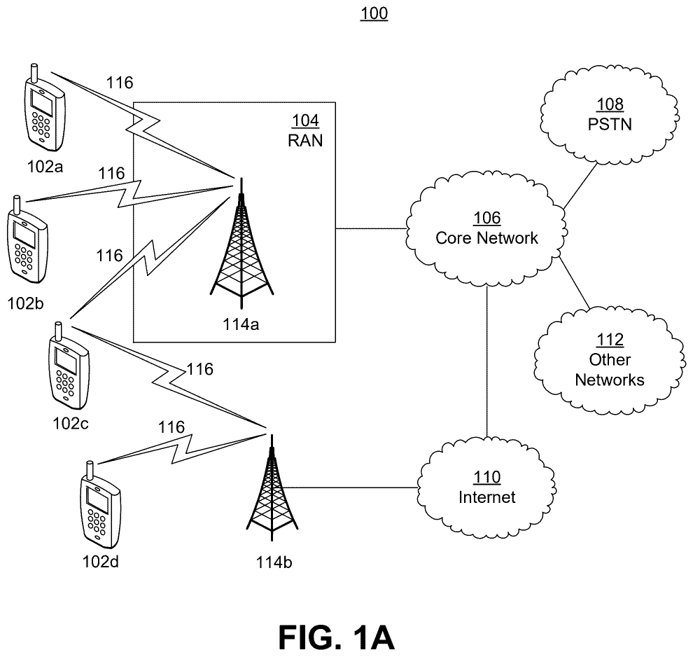

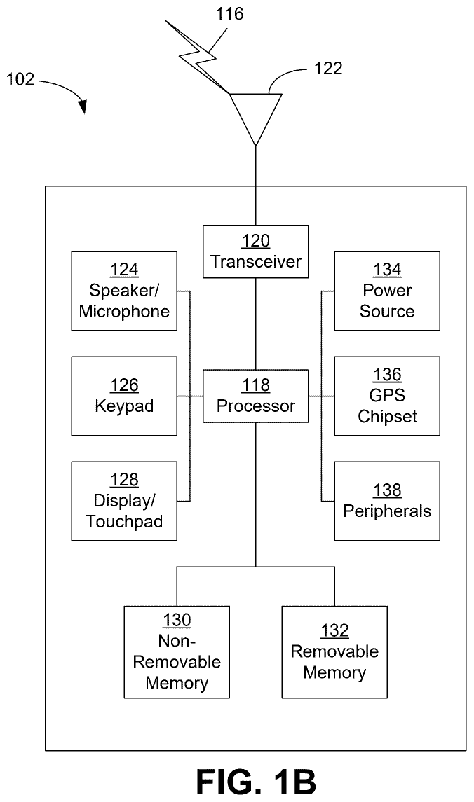

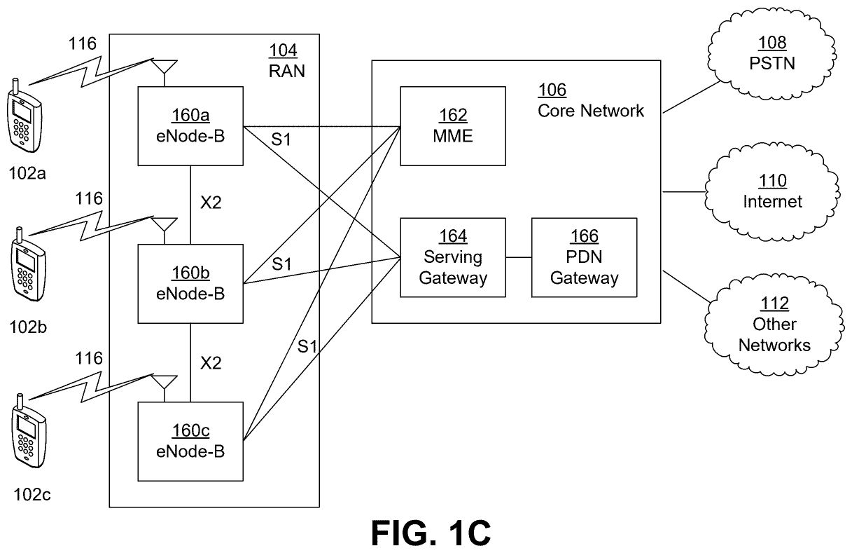

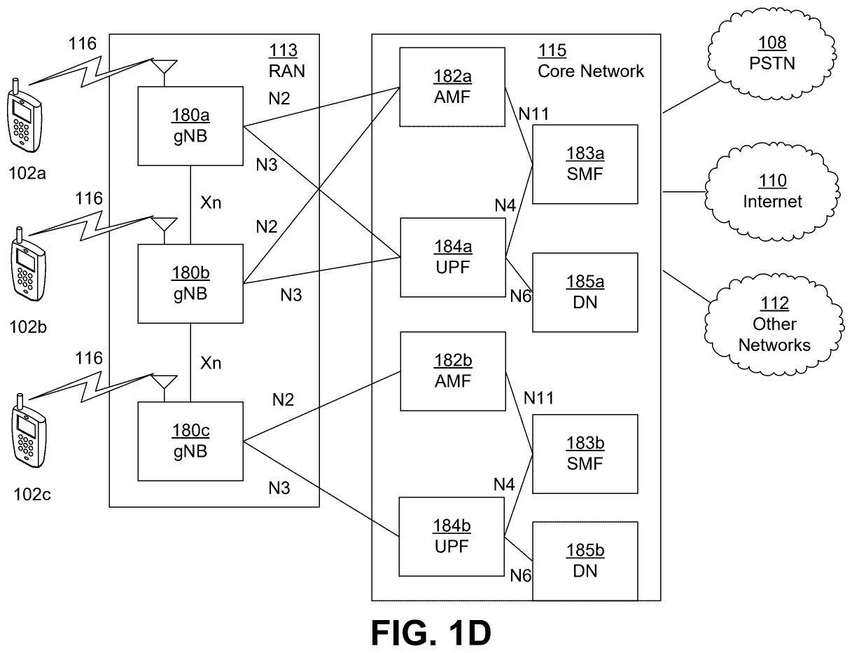

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Artificial intelligence (AI) may be referred to as the behavior exhibited by machines. Such behave may, for example, mimic cognitive functions to sense, reason, adapt, and/or act. The terms AI, machine learning (ML), deep learning (DL), and/or deep neural network (DNN) may be used interchangeably. Methods described herein may be exemplified based on learning in wireless communication systems. The methods may not be limited to such scenarios, systems, and/or services, and/or may be applicable to one or more (e.g., any) type of transmission(s), communication system(s), service(s), etc. The performance of an AI/ML model may be tied to the quality of the training dataset and/or similarity between the train and/or test data.

The use of machine learning (ML)-based model for different physical (PHY) applications may be described herein. Life cycle management (LCM) and/or deployment related challenges may be addressed herein. From the point of view of deploying ML methods in real world systems and/or monitoring and/or estimating their performance, the dataset utilized for training the model may play a (e.g., significant) role. If the data at inference time is dis-similar to the training data, for example, the ML model may include un-reliable and/or poor performance. Detecting such situations and/or employing fallback procedures (e.g., model switching, non-ML methods, etc.) may be included in one or more embodiments described herein. Embodiments described herein may utilize a dataset similarity framework that can detect similarity and/or differences between datasets and/or can be employed for applications such as model switching, performance prediction(s), out-of distribution (OOD) detection and/or associate ID management.

Embodiments described herein include one or more methods and/or apparatuses configured for dataset similarity-based model switching.

A wireless transmit/receive unit (WTRU) may receive configuration information. The configuration may include dataset similarity configuration information. The WTRU may be configured with an artificial intelligence machine learning (AIML) model and/or a plurality of training data sets associated with the AIML model. The WTRU may be configured with a plurality of AIML models. Each AIML model of the plurality of AIML models may be associated with one or more training data sets. The WTRU may generate a data sample set based on the dataset similarity configuration information. The WTRU may determine a (e.g., first) dataset similarity value for a (e.g., first) AIML model (e.g., of the plurality of AIML models). The (e.g., first dataset similarity value may be determined based on the dataset similarity configuration information, the data sample set, and/or each training data set associated with each AIML model. The dataset similarity value for the training data set(s) may indicate a similarity between the training data set(s) associated with the (e.g., first) AIML model and the data sample set. The WTRU may send an indication to a base station. The indication may indicate the (e.g., first) dataset similarity value and/or a preferred (e.g., second) AIML model (e.g., of the plurality of AIML models).

A WTRU may receive configuration information. The configuration information may include dataset similarity configuration information. The WTRU may be configured with a plurality of artificial intelligence machine learning (AIML) models and/or training information (e.g., one or more training data sets) associated with each AIML model of the plurality of AIML models. The WTRU may generate a data sample set based on the dataset similarity configuration information. The WTRU may determine a dataset similarity value for the (e.g., first AIML) model based on the dataset similarity configuration information, the data sample set, and/or the training data set associated with the (e.g., first) AIML model. The dataset similarity value may indicate a similarity between the training data set associated with each (e.g., the first) AIML model and the data sample set. The WTRU may send an indication to a base station. The indication may indicate the first dataset similarity value and/or a preferred AIML model (e.g., of the plurality of AIML models).

A WTRU may receive configuration information. The configuration information may include dataset similarity configuration information. The WTRU may be configured with a plurality of training data sets and/or an AIML model. The WTRU may generate a data sample set associated with the AIML model. The WTRU may determine a dataset similarity value for the AIML model based on the dataset similarity configuration information, the plurality of training data sets, and/or the data sample set. The dataset similarity value may indicate a similarity between the plurality of training data sets associated with the AIML model and the data sample set. The WTRU may send an indication to a base station. The indication may indicate the dataset similarity value and/or a preferred AIML model.

A WTRU may receive configuration information. The configuration information may include dataset similarity configuration information. The WTRU may be configured with a plurality of training data sets and/or a plurality of AIML models. The WTRU may generate a data sample set associated with the plurality of AIML models. The WTRU may determine a dataset similarity value for each AIML model based on the dataset similarity configuration information, the plurality of training data sets, and/or the data sample set. The dataset similarity value may indicate a similarity between the plurality of training data sets associated with each AIML model of the plurality of AIML models and the data sample set. The WTRU may send an indication to a base station. The indication may indicate the dataset similarity value and/or a preferred AIML model (e.g., of the plurality of AIML models).

A wireless transmit/receive unit (WTRU) may measure and/or report K similarity metrics between K sets of (pre)configured, representative, training data sets and an inference dataset, corresponding to the set of data samples being observed and/or received at the time of operation. The WTRU and/or base station (BS) may utilize these similarity and/or distance values for performance monitoring, model switching, OOD detection, and/or the like.

A WTRU may be configured with a dataset similarity configuration. The dataset similarity configuration may include one or more of a similarity metric, one or more error thresholds, performance prediction curve(s), a minimum number of data samples, one or more dimensions of the lower dimensional space to project the data into (e.g., L), and/or a dimensionality reduction method (e.g., R(⋅)), for example, to reduce the dataset dimensionality. The dataset similarity configuration may include pre-process configuration to determine similarity between a data sample set (e.g., S_{inf}) and a training data set (e. g., Dᵢ). For example, pre-processing may refer to an extra set of processing that the data undergoes before the dataset similarity evaluation. Examples of pre-processing may include one or more of: normalizing the data to make it zero mean, unit variance, scaling the data, and/or the like. The data sample set may indicate current channel condition(s). The data sample set may be configured to be operated on by the (e.g., first) AIML model. The data sample set may have the same format (and/or is of the same data type) as the training data set(s). A WTRU may receive configuration information. The configuration may include dataset similarity configuration information. The WTRU may be configured with a plurality of artificial intelligence machine learning (AIML) models and/or training data set associated with each AIML model of the plurality of AIML models. The WTRU may be configured with a plurality of training data sets associated with each AIML model. The WTRU may be configured with a AIML model associated with one or more training data sets. The dataset similarity configuration may include one or more of: a similarity metric, one or more thresholds, and/or performance prediction curves. The WTRU may determine the first dataset similarity value based on the similarity metric, the one or more thresholds, and/or the performance prediction curves. The (e.g., first) dataset similarity value may indicate and/or be a proxy for a performance of the first AIML model for current channel conditions (e.g., where the data sample set indicates the current channel conditions).

The WTRU may be configured with a similarity metric (e.g., S(⋅)). The similarity metric may be defined such that the model performance on a first dataset and a second dataset may be similar if the similarity metric between the first dataset and the second dataset is below a threshold. For example, the similarity metric may include one or more of the following. The similarity metric may include one or more geometric distances (e.g., pairwise Euclidean, centroid wise Euclidean, cluster wise Euclidean, cosine, etc.). The similarity metric may include one or more statistical distances (e.g., Kullback-Leibler (KL), Jensen Sannon, Wasserstein, Hellinger, Total Variation, etc.). The similarity metric a manifold and/or subspace. For example, the similarity metric may include Grassman and/or Chordal.

The WTRU may be configured with one or more error thresholds. The error thresholds may identify the operating range within which the performance of the model is expected to be sufficient (e.g., within a certain tolerance of one or more expected KPIs). For example, a first threshold may include a minimum required similarity below which model switching may be triggered. For example, a second threshold may include a minimum required similarity for reasonable (e.g., within a certain tolerance of one or more expected KPIs) performance. For example, the WTRU may be configured with a threshold associated with a number of failure samples within a given window of time. For example, a failure sample may include an outcome of a model that is not within a certain tolerance of one or more expected KPIs.

The WTRU may be configured with one or more performance prediction curves. A curve may include, for example, a predefined mapping and/or function to predict the ML model performance based on the dataset similarity and/or distance metric.

The WTRU may be configured with a minimum number of data samples (e.g., N) to be accumulated. The WTRU may determine similarity based on the minimum number of data samples. For example, the minimum number of data samples may include a first value N1 for the online samples and/or a second value N2 for offline samples. Offline samples may include samples collected during an offline data collection effort (e.g., not during an active call and/or connection). This may be based on one or more (e.g., some) past datasets, past samples collected, and/or the like. Online samples may include samples collected during the active connection with the network. For example, a WTRU may receive CSI-RS; the WTRU may use the CSI-RS to estimate the CSI. The estimated CSI sample may be stored as part of the online collected sample set. The WTRU may determine similarity based on the first value (e.g., N1) and/or the second value (e.g., N2). The dataset similarity configuration information may include an indication that indicates a minimum number of data samples and/or a period of time. The WTRU may generate the data sample set based on the minimum number of data samples and/or the period of time.

The WTRU may be configured with dimension(s) of the lower dimensional space to project the data into (e.g., L). The WTRU may be configured with a dimensionality reduction method (e.g., R(⋅)) to reduce the dataset dimensionality. The dimensionality method may map a given dataset (e.g., the first and/or the second dataset) to a lower dimensional space. For example, the dimensionality of the lower dimensional space may be assumed to be specified. The dataset similarity configuration information may include a lower dimensional space value. The WTRU may use a dimensionality reduction method to determine, based on the lower dimensional space value, a reduced dataset dimensionality of the data sample set and/or a reduced dimensionality of the training data set associated with the first AIML model. The (e.g., first) dataset similarity value may be determined based on the reduced dataset dimensionality of the data sample set and/or the reduced dimensionality of the training data set associated with the first AIML model.

The WTRU may be configured with one or more of the following for each ML use case (e.g., channel state information (CSI) compression, CSI prediction, channel estimation, etc.) at the WTRU. The WTRU may be configured with a set of K ML models that may be utilized of the specified application: {M₁, M₂, . . . , M_{K}}. The WTRU may be configured with a training dataset and/or a dataset distribution corresponding to the training data that was used for each of the K ML models: {D₁, D₂, . . . , D_{K}}. For example, the WTRU may be configured to use the (e.g., first) AIML model to perform one or more of: channel state information (CSI) compression, CSI prediction, channel estimation, and/or beam management.

The WTRU may activate model Mᵢ for an example use case (e.g., CSI compression). For example, the WTRU may determine to activate model Mᵢ based on network configuration.

The WTRU may generate a data sample set based on the dataset similarity configuration information. The WTRU may generate a data sample set based on the dataset similarity configuration information and/or based on or for the AIML model. The WTRU may collect one or more data samples to form data sample set S_{inf} (e.g., based on WTRU measurement(s)) such that: 1) a time difference between the first and last sample in the data sample set is above a first threshold and/or below a second threshold; and/or 2) the size of the data sample set is above a (pre)configured value N (e.g., a minimum number of samples and/or a maximum number of samples). For example, for CSI compression sample, the WTRU may: receive CSI-reference signal (RS); may measure the CSI; and/or may store CSI sample(s) for a period of N time slots.

The WTRU may derive dataset similarity. For example, the WTRU may determine a (e.g., first) dataset similarity value. Given a set of N CSI samples, S_{inf}, the WTRU may evaluate the dataset similarity between S_{inf} and the training set Dᵢ (e.g., associated with the active model Mᵢ) based on one or more of the following. The WTRU may pre-process the data using pre-processing configuration. The WTRU may apply the dimensionality reduction scheme (e. g., R(⋅)) to project the data to a L dimensional space. The WTRU may derive the dataset similarity metric. For example, the WTRU may determine a (e.g., first) dataset similarity value for an (e.g., a first) AIML model of the plurality of AIML models. The first dataset similarity value may be determined based on the dataset similarity configuration information, the data sample set, and training data set(s) associated with the (e.g., first) AIML model (e.g., of the plurality of AIML models). The (e.g., first) dataset similarity value for the training data set may indicate a similarity between the training data set associated with the (e.g., first) AIML model and the data sample set. The WTRU may compare the data sample set to the training data set(s) of the (e.g., first) AIML model to determine the (e.g., first) dataset similarity value. The WTRU may determine the (e.g., first) similarity metric using one or more of a geometric-based distance, a statistical-based distance, and/or a manifold-based metric The geometric-based distance may include one or more of a pairwise Euclidean-based metric, a centroid wise Euclidean-based metric, a cluster wise Euclidean-based metric, and/or a cosine-based metric. The statistical-based distance may include one or more of a kullback-leiber divergence-based metric, a Jensen Shannon-based metric, a Wasserstein-based metric, a Hellinger-based metric, and/or a total variation-based metric. The manifold metric may include one or more of a Grassmann-based metric and/or a chordal-based metric.

The WTRU may be configured to perform model switching. The WTRU may perform model switching as a function of the dataset similarity metric. For example, if the first (e.g., current) dataset similarity is below a first threshold, the WTRU may derive dataset similarity between S_{inf} and each of the remaining training datasets {D₁, D₂, . . . , D_{K}}. For example, the WTRU may determine that the (e.g., first) dataset similarity value for the (e.g., first) AIML model is below a threshold. The WTRU may determine another (e.g., a second) dataset similarity value for a second AIML model of the plurality of AIML models based on the dataset similarity configuration information, the data sample set, and/or the training data set(s) associated with the second AIML model. The WTRU may determine that the second dataset similarity value is above the threshold. The preferred AIML model indicated by the indication may be the second AIML model.

If the highest similarity between S_{inf} and a remaining training dataset (e.g., D₁) is above a (e.g., first) threshold, the WTRU may switch to the model Mᵢ corresponding to the dataset (e.g., D₁, Dᵢ) with the highest similarity to the set S_{inf}. For example, the WTRU may determine that the first dataset similarity value for the (e.g., first) AIML model is below a threshold. The WTRU may determine a second dataset similarity value for a second AIML model of the plurality of AIML models based on the dataset similarity configuration information, the data sample set, and/or the training data set(s) associated with the second AIML model. The WTRU may determine that the second dataset similarity value is above the threshold. The WTRU may activate the second AIML model based on the second dataset similarity value being above the threshold.

If the highest similarity between S_{inf} and a remaining training dataset (e.g., D₁) is below a (e.g., second) threshold, the WTRU may fall back to another (e.g., legacy) CSI reporting and/or the WTU may request the base station for additional model(s) and/or corresponding dataset(s). For example, the WTRU may determine that the (e.g., first) dataset similarity value for the (e.g., first) AIML model is below a threshold. The WTRU may determine a second dataset similarity value for a second AIML model of the plurality of AIML models based on the dataset similarity configuration information, the data sample set, and/or the training data set(s) associated with the second AIML model. The WTRU may determine that the second dataset similarity value is below a second threshold. The WTRU may fallback to other (e.g., legacy) operation and/or may send a request to the base station for an additional (e.g., AIML) model (and/or corresponding data set(s)).

The WTRU may send an indication, for example, to a base station. For example, the WTRU may report, to the base station, the identity of the (e.g., recently) selected model and/or the corresponding similarity value. For example, the WTRU may send an indication to the base station. The indication may indicate the identity of the identity of the (e.g., recently) selected model and/or the corresponding similarity value. For example, the WTRU may send an indication to a base station. The indication may indicate the first dataset similarity value and/or a preferred (e.g., second) AIML model of the plurality of AIML models. When the first dataset similarity value is less than a threshold, the WTRU may send a message to a base station. The message may include an indication that indicates a request for one or more additional AIML models and/or corresponding datasets.

Embodiments described herein may avoid the requirement to run (e.g., costly) inference over one or more (e.g., multiple) data points to gauge the model performance. Embodiments described herein may include saving on (e.g., costly) training and/or retraining procedures. Embodiments described herein may include the selection of a pre-trained model, from a set of pre-trained models, by evaluating (e.g., cost effective) dataset similarity metric(s) (e.g., without requiring inference on one or more data points).

Embodiments described herein may include methods and/or apparatuses configured for dataset similarity-based performance monitoring and/or performance prediction. A WTRU and/or base station may measure and/or report similarity metric(s) between training dataset(s) and an inference dataset. The WTRU and/or base station may utilize these similarity and/or distances for performance monitoring.

A WTRU may be configured with a dataset similarity configuration. The dataset similarity configuration may include one or more of a similarity metric, one or more error thresholds, performance prediction curve(s), a minimum number of data samples, one or more dimensions of the lower dimensional space to project the data into (e.g., L), and/or a dimensionality reduction method (e.g., R(⋅)), for example, to reduce the dataset dimensionality. The dataset similarity configuration may include pre-process configuration to determine similarity between a data sample set (e.g., S_{inf}) and a training data set (e. g., Dᵢ). For example, pre-processing may refer to an extra set of processing that the data undergoes before the dataset similarity evaluation. Examples of pre-processing may include one or more of: normalizing the data to make it zero mean, unit variance, scaling the data, and/or the like. The data sample set may indicate current channel condition(s). The data sample set may be configured to be operated on by the (e.g., first) AIML model. The data sample set may have the same format (and/or is of the same data type) as the training data set(s). A WTRU may receive configuration information. The configuration may include dataset similarity configuration information. The WTRU may be configured with a plurality of artificial intelligence machine learning (AIML) models and/or training data set associated with each AIML model of the plurality of AIML models. The dataset similarity configuration may include one or more of: a similarity metric, one or more thresholds, and/or performance prediction curves. The WTRU may determine the first dataset similarity value based on the similarity metric, the one or more thresholds, and/or the performance prediction curves. The (e.g., first) dataset similarity value may indicate and/or be a proxy for a performance of the first AIML model for current channel conditions (e.g., where the data sample set indicates the current channel conditions).

The WTRU may be configured with a similarity metric (e.g., S(⋅)). The similarity metric may be defined such that the model performance on a first dataset and a second dataset may be similar if the similarity metric between the first dataset and the second dataset is below a threshold. For example, the similarity metric may include one or more of the following. The similarity metric may include one or more geometric distances (e.g., pairwise Euclidean, centroid wise Euclidean, cluster wise Euclidean, cosine, etc.). The similarity metric may include one or more statistical distances (e.g., KL, Jensen Sannon, Wasserstein, Hellinger, Total Variation, etc.). The similarity metric a manifold and/or subspace. For example, the similarity metric may include Grassman and/or Chordal.

The WTRU may be configured with one or more error thresholds. The error thresholds may identify the operating range within which the performance of the model is expected to be sufficient (e.g., within a certain tolerance of one or more KPIs). For example, a first threshold may include a minimum required similarity below which model switching may be triggered. For example, a second threshold may include a minimum required similarity for reasonable performance (e.g., within a certain tolerance of one or more KPIs). For example, the WTRU may be configured with a threshold associated with a number of failure samples within a given window of time. For example, a failure sample may refer to a scenario when the dataset similarity is below a threshold; the model performance may be expected to be low/weak (e.g., not within a tolerance of one or more KPIs).

The WTRU may be configured with one or more performance prediction curves. A curve may include, for example, a predefined mapping and/or function to predict the ML model performance based on the dataset similarity and/or distance metric.

The WTRU may be configured with a minimum number of data samples (e.g., N) to be accumulated. The WTRU may determine similarity based on the minimum number of data samples. For example, the minimum number of data samples may include a first value N1 for the online samples and/or a second value N2 for offline samples. Offline samples may include samples collected during an offline data collection effort (e.g., not during an active call and/or connection). This may be based on one or more (e.g., some) past datasets, past samples collected, and/or the like. Online samples may include samples collected during the active connection with the network. For example, a WTRU may receive CSI-RS; the WTRU may use the CSI-RS to estimate the CSI. The estimated CSI sample may be stored as part of the online collected sample set. The WTRU may determine similarity based on the first value (e.g., N1) and/or the second value (e.g., N2). The dataset similarity configuration information may include an indication that indicates a minimum number of data samples and/or a period of time. The WTRU may generate the data sample set based on the minimum number of data samples and/or the period of time.

The WTRU may be configured with dimension(s) of the lower dimensional space to project the data into (e.g., L). The WTRU may be configured with a dimensionality reduction method (e.g., R(⋅)) to reduce the dataset dimensionality. The dimensionality method may map a given dataset (e.g., the first and/or the second dataset) to a lower dimensional space. For example, the dimensionality of the lower dimensional space may be assumed to be specified. The dataset similarity configuration information may include a lower dimensional space value. The WTRU may use a dimensionality reduction method to determine, based on the lower dimensional space value, a reduced dataset dimensionality of the data sample set and/or a reduced dimensionality of the training data set associated with the first AIML model. The (e.g., first) dataset similarity value may be determined based on the reduced dataset dimensionality of the data sample set and/or the reduced dimensionality of the training data set associated with the first AIML model.

The WTRU may be configured with one or more of the following for each ML use case (e.g., channel state information (CSI) compression, CSI prediction, channel estimation, etc.) at the WTRU. The WTRU may be configured with a set of K ML models that may be utilized of the specified application: {M₁, M₂, . . . , M_{K}}. The WTRU may be configured with a training dataset and/or a dataset distribution corresponding to the training data that was used for each of the K ML models: {D₁, D₂, . . . , D_{K}}. For example, the WTRU may be configured to use the (e.g., first) AIML model to perform one or more of: channel state information (CSI) compression, CSI prediction, channel estimation, and/or beam management.

The WTRU may activate model Mᵢ for an example use case (e.g., CSI compression). For example, the WTRU may determine to activate model Mᵢ based on network configuration.

The WTRU may generate a data sample set based on the dataset similarity configuration information. The WTRU may generate a data sample set based on the dataset similarity configuration information and/or based on or for the AIML model. The WTRU may collect one or more data samples to form data sample set S_{inf} (e.g., based on WTRU measurement(s)) such that: 1) a time difference between the first and last sample in the data sample set is above a first threshold and/or below a second threshold; and/or 2) the size of the data sample set is above a (pre)configured value N (e.g., a minimum number of samples and/or a maximum number of samples). For example, for CSI compression sample, the WTRU may: receive CSI-reference signal (RS); may measure the CSI; and/or may store CSI sample(s) for a period of N time slots.

The WTRU may evaluate one or more (e.g., multiple) performance estimates based on dataset similarity.

For example, the WTRU may calculate a first performance estimate (e.g., P1) based on WTRU-based station joint similarity evaluation. The WTRU may evaluate dataset similarity between Dᵢ and S_{inf}. The WTRU may report the similarity. The WTRU may share information about the samples in S_{inf} and/or the window start and/or end indices used to evaluate S_{inf}. The WTRU may request dataset similarity between Dᵢ and the reconstructed samples corresponding to S_{inf} from the BS. If the difference between the WTRU's similarity and the base stations' similarity is above a threshold, the model's performance may be weak/low and/or unreliable. For example, a performance metric may include

$$P 1 = 1 - \frac{{Similarity}_{U E} - {Similarity}_{B S}}{{Similarity}_{U E}} .$$

For example, the WTRU may calculate a second performance estimate (e.g., P2) using a predefined mapping (e.g., performance curves). The WTRU may evaluate dataset similarity between Dᵢ and S_{inf}. The WTRU may utilize the performance curve(s) to estimate the performance of the model (e.g., for CSI compression) from (e.g., directly from) the dataset similarity and/or distances. Based on the performance, for example, the WTRU may employ one or more (e.g., other, fallback) procedures. For example, the second performance metric may include:

$$P 3 = \frac{{Similarity}_{U E}}{c 3} ,$$

where c2 may be a scaling and/or normalizing factor.

For example, the WTRU may calculate a third performance estimate (e.g., P3) for out-of distribution detection. The WTRU may employ pointwise similarity (e.g., geometric distance metrics) to evaluate similarity between an individual data point (e.g., CSI sample) and the dataset Dᵢ. For example, the third performance metric may include

$$P2 = \frac{P C u rve ( {Similarity}_{U E} )}{c 2} ,$$

where c3 may be a scaling/normalizing factor.

The WTRU may employ a weighted combination of performance metric(s) and/or threshold(s) to perform an estimate of the performance of model Mᵢ. For example, a function to determine performance of model Mᵢ may include: Performance=w1 P1+w2P2+w3P3

The WTRU may report the estimated performance to the base station. For example, the WTRU may send an indication indicating the estimated performance periodically (e.g., at a cadence) and/or when the performance drops below a (pre) defined threshold.

Embodiments described herein may include methods and/or apparatuses configured for dataset similarity-based associate ID management. A WTRU may measure a similarity metric between the dataset corresponding to the active associate ID and an inference dataset, corresponding to the set of data samples being observed and/or received at the time of operation. The WTRU and/or base station may utilize these similarity values for associate ID management, for example, creating another (e.g., new) associate ID.

A WTRU may be configured with a dataset similarity configuration. The dataset similarity configuration may include one or more of a similarity metric, one or more error thresholds, performance prediction curve(s), a minimum number of data samples, one or more dimensions of the lower dimensional space to project the data into (e.g., L), and/or a dimensionality reduction method (e.g., R(⋅)), for example, to reduce the dataset dimensionality. The dataset similarity configuration may include pre-process configuration to determine similarity between a data sample set (e.g., S_{inf}) and a training data set (e. g., Dᵢ). For example, pre-processing may refer to an extra set of processing that the data undergoes before the dataset similarity evaluation. Examples of pre-processing may include one or more of: normalizing the data to make it zero mean, unit variance, scaling the data, and/or the like. The data sample set may indicate current channel condition(s). The data sample set may be configured to be operated on by the (e.g., first) AIML model. The data sample set may have the same format (and/or is of the same data type) as the training data set(s). A WTRU may receive configuration information. The configuration may include dataset similarity configuration information. The WTRU may be configured with a plurality of artificial intelligence machine learning (AIML) models and/or training data set associated with each AIML model of the plurality of AIML models. The dataset similarity configuration may include one or more of: a similarity metric, one or more thresholds, and/or performance prediction curves. The WTRU may determine the first dataset similarity value based on the similarity metric, the one or more thresholds, and/or the performance prediction curves. The (e.g., first) dataset similarity value may indicate and/or be a proxy for a performance of the first AIML model for current channel conditions (e.g., where the data sample set indicates the current channel conditions).

The WTRU may be configured with a similarity metric (e.g., S(⋅)). The similarity metric may be defined such that the model performance on a first dataset and a second dataset may be similar if the similarity metric between the first dataset and the second dataset is below a threshold. For example, the similarity metric may include one or more of the following. The similarity metric may include one or more geometric distances (e.g., pairwise Euclidean, centroid wise Euclidean, cluster wise Euclidean, cosine, etc.). The similarity metric may include one or more statistical distances (e.g., KL, Jensen Sannon, Wasserstein, Hellinger, Total Variation, etc.). The similarity metric a manifold and/or subspace. For example, the similarity metric may include Grassman and/or Chordal.

The WTRU may be configured with one or more error thresholds. The error thresholds may identify the operating range within which the performance of the model is expected to be sufficient (e.g., within a certain tolerance of one or more KPIs). For example, a first threshold may include a minimum required similarity below which model switching may be triggered. For example, a second threshold may include a minimum required similarity for reasonable performance (e.g., within a certain tolerance of one or more KPIs). For example, the WTRU may be configured with a threshold associated with a number of failure samples within a given window of time. For example, a failure sample may refer to a scenario when the dataset similarity is below a threshold; the model performance may be expected to be low/weak (e.g., not within a tolerance of one or more KPIs).

The WTRU may be configured with one or more performance prediction curves. A curve may include, for example, a predefined mapping and/or function to predict the ML model performance based on the dataset similarity and/or distance metric.

The WTRU may be configured with a minimum number of data samples (e.g., N) to be accumulated. The WTRU may determine similarity based on the minimum number of data samples. For example, the minimum number of data samples may include a first value N1 for the online samples and/or a second value N2 for offline samples. Offline samples may include samples collected during an offline data collection effort (e.g., not during an active call and/or connection). This may be based on one or more (e.g., some) past datasets, past samples collected, and/or the like. Online samples may include samples collected during the active connection with the network. For example, a WTRU may receive CSI-RS; the WTRU may use the CSI-RS to estimate the CSI. The estimated CSI sample may be stored as part of the online collected sample set. The WTRU may determine similarity based on the first value (e.g., N1) and/or the second value (e.g., N2). The dataset similarity configuration information may include an indication that indicates a minimum number of data samples and/or a period of time. The WTRU may generate the data sample set based on the minimum number of data samples and/or the period of time.

The WTRU may be configured with dimension(s) of the lower dimensional space to project the data into (e.g., L). The WTRU may be configured with a dimensionality reduction method (e.g., R(⋅)) to reduce the dataset dimensionality. The dimensionality method may map a given dataset (e.g., the first and/or the second dataset) to a lower dimensional space. For example, the dimensionality of the lower dimensional space may be assumed to be specified. The dataset similarity configuration information may include a lower dimensional space value. The WTRU may use a dimensionality reduction method to determine, based on the lower dimensional space value, a reduced dataset dimensionality of the data sample set and/or a reduced dimensionality of the training data set associated with the first AIML model. The (e.g., first) dataset similarity value may be determined based on the reduced dataset dimensionality of the data sample set and/or the reduced dimensionality of the training data set associated with the (e.g., first) AIML model.

The WTRU may be configured with one or more of the following for each ML use case (e.g., channel state information (CSI) compression, CSI prediction, channel estimation, etc.) at the WTRU. The WTRU may be configured with a set of K ML models that may be utilized of the specified application: {M₁, M₂, . . . , M_{K}}. The WTRU may be configured with a training dataset and/or a dataset distribution corresponding to the training data that was used for each of the K ML models: {D₁, D₂, . . . , D_{K}}. For example, the WTRU may be configured to use the first AIML model to perform one or more of: channel state information (CSI) compression, CSI prediction, channel estimation, and/or beam management.

The WTRU may be configured with a plurality of associate IDs {ID₁, ID₂, . . . . ID_{K}} and the corresponding datasets {DA₁, . . . . DA_{K}}.

The WTRU may activate model Mᵢ for an example use case (e.g., CSI compression). For example, the WTRU may determine to activate model Mᵢ based on network configuration.

The WTRU may receive the active associate ID IDᵢ.

The WTRU may collect one or more data samples (e.g., as described herein) to form data sample set S_{inf}. The WTRU may collect the one or more data samples based on WTRU measurements.

The WTRU may derive dataset similarity between current data sample(s), S_{inf} and data associated with the active associate ID, IDᵢ. {DAᵢ}. If similarity associated with the active associate is below a threshold, the WTRU may report, to the base station, about associate ID drift.

Embodiments described herein may include configuration for dataset distancing based on performance monitoring, model switching, OOD detection, and/or associate ID management. In a setting, a measure of similarity may be evaluated between two given datasets (e.g., a first dataset and a second dataset). This measure of similarity may be utilized to estimate and/or predict (e.g., as a proxy) how a model trained on a dataset may perform when deployed in a second setting. To utilize such framework at a WTRU, the WTRU may be configured with one o more of the following.

A WTRU may be configured with a similarity metric and/or a distance measure and/or metric to evaluate the similarity between two or more datasets. A similarity metric, S(⋅) may take as input two or more datasets with one or more data points in each of the dataset and/or may provide a similarity value. Different similarity metric may be utilized for this purpose (e.g., geometric distances, statistical distances, manifold distances, sub-space distances, and/or the like).

In examples, the WTRU may be configured to utilize geometric based distances and/or metrics, which may measure and/or evaluate similarity by measuring/evaluating/quantifying the relationship(s) between data points (e.g., directly) in the data space, for example, without mapping the data through one or more (e.g., any) intermediary sub-space/latent space. For example, the WTRU may determine a similarity metric by evaluating Euclidean distance (e.g., straight line distance between points), Manhattan distance (e.g., sum of absolute differences across each dimension), cosine similarity (e.g., angular gap between data points), and/or the like. With respect to Euclidean distance, if sₖ is the k-th data point from the set S_{inf} and

$${s}_{l}^{i}$$

is the t-th data points from the set training dataset Dᵢ, the Euclidean distance between the points maybe evaluated as

$${‖ {s}_{k} - {s}_{l}^{i} ‖}_{2} ,$$

where ∥⋅∥₂ may represent the 2-norm. With respect to cosine similarity, the cosine similarity between two data points may be calculated as

$${d}_{kl} = \frac{{s}_{k}^{T} {s}_{l}^{i}}{‖ {s}_{k} ‖ ‖ {s}_{l}^{i} ‖} .$$

The distance(s) may be evaluated in one or more (e.g., several) ways. In examples, the distance(s) between the datasets may be evaluated in a pairwise fashion across one or more (e.g., all) pairs of datapoint, across the two datasets (e.g., one point from each dataset).

In examples, the distances may be evaluated in a grouped and/or clustered fashion. Each of the datasets may (e.g., first) be grouped and/or clustered. The distances may be evaluated between the clusters and/or the representative data points of and/or from each cluster (e.g., cluster center, centroid, cluster representative, and/or the like).

In examples, the distances may be evaluated in a pairwise fashion for (e.g., only) a subset of representative datapoints of and/or from each of the datasets.

In examples, the WTRU may be configured to utilize statistical distances which may measure and/or evaluate similarity by measuring/evaluating/quantifying the difference between the probability distributions of the datasets. The statistical distances may (e.g., also) measure differences between the statistical properties of the datasets.

In examples, the distance and/or similarity may be evaluated as a divergence metric between the datasets (e.g., using Jensen Shannon divergence, KL Divergence, etc.). The function ƒ_{D}_{ᵢ}(x) may represent the probability distribution associated with the training data Dᵢ. The function ƒₛ_{_{inf}}(x) may represent the probability distribution associated with the inference dataset S_{inf}. The KL divergence between the two distributions over the domain [symbol] may be evaluated as:

$${D}_{KL} ( {f}_{{D}_{i}} ‖ {f}_{{S}_{inf}} ) = {\sum }_{x ∈ {𝒟}_{x}} {f}_{{D}_{i}} ( x ) log \frac{{f}_{{D}_{i}} ( x )}{{f}_{{S}_{inf}} ( x )} \qquad Equation ( 1 )$$

In examples, the one or more other statistical and/or probability-based distances metrics may be utilized. For example, the WTRU may (e.g., also) use mean discrepancy and/or total variation distance(s). For example, the WTRU may use Wasserstein distance (e.g., that may evaluate the minimum probability mass that needs to be transferred from a first probability distribution, corresponding to a first dataset, to a second probability distribution, corresponding to a second dataset, to make the second distribution similar to the first probability distribution). The Wasserstein distance between two distributions may be evaluated as:

$$W ( {f}_{{DA}_{i}} , {f}_{{S}_{inf}} ) = {( {\sum }_{{x}_{k} {x}_{l} ∈ {𝒟}_{x}} {d ( {x}_{k} , {x}_{l} )}^{p} {γ}_{kl} )}^{\frac{1}{p}} \qquad Equation ( 2 )$$

The term p may be the order of the Wasserstein distance, d(⋅) may be the distance between the samples, and/or Y_{k,i} may be the (e.g., optimal) transportation plan (e.g., evaluated using separate optimization process).

In examples, the WTRU may be configured to utilize manifold based distances and/or metrics, which may measure and/or evaluate similarity by assuming that the data points lie on a curved and/or non-linear manifold while evaluating the distances. For example, a WTRU may be configured to evaluate the distance over a sphere manifold, using geodesic distances.

In examples, the WTRU may be configured to utilize subspace-based distances and/o metrics, which may measure and/or evaluate similarity by evaluating the underlying sub-space associated with each of the datasets and/or (e.g., then) evaluating the distances between the sub-spaces. For example, the WTRU may be configured to use a Grassmannian distance to measure the distance between subspaces on a Grassmannian manifold.

In examples, the WTRU may be configured with one or more (e.g., multiple) thresholds to evaluate the dataset similarity metric and/or to utilize the measured similarity value(s) for downstream task(s)/decision making/reporting at the WTRU.

In examples, the WTRU may be configured with a first threshold and/or a second threshold. The first threshold and/or second threshold may represent the (e.g., required) dataset similarity between a trained dataset and an inference dataset, for example, to evaluate the performance of an artificial intelligence machine learning (AIML) model on the inference dataset. The first threshold may include a minimum similarity metric value below which an AIML model performance may be registered as insufficient and/or a failure. The second threshold may include a minimum similarity metric value below which other (e.g., fallback) procedures may be deployed.

In examples, the WTRU may be configured with a threshold TN on the minimum number of a failure samples within a given window of time. If a number of failure samples encountered within the window of time exceed the threshold TN, for example, the WTRU may be configured to switch the (e.g., AIML) model and/or may employ fallback procedure(s).

In examples, the WTRU may be configured with performance prediction curves. The WTRU may use the performance prediction curves, using the dataset similarity measurements, to estimate the performance of an (e.g., AIML) mode on an inference dataset. In examples, performance prediction curve may be a function ƒₚ(⋅), which may take the dataset similarity as its input(s) and/or may output an estimate of the AIML model. For each AIML task, there may be an independent function of performance prediction curve.

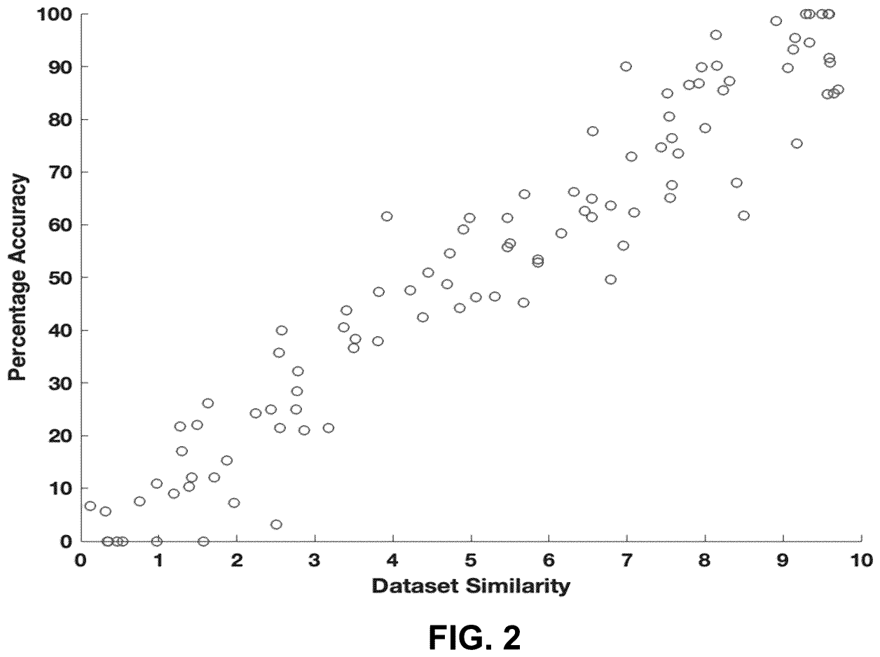

FIG. 2 depicts an example of an example of a performance prediction curve. As seen from the curve the dataset similarity and/or model performance may be (e.g., highly) correlated. A curve (e.g., as FIG. 2 depicts) may be utilized to estimate the accuracy of the ML model given the dataset similarity measurement.

In examples, the performance prediction curve may be represented as a lookup table. The WTRU may be configured to use the lookup table to estimate model performance for each value of the dataset similarity.

In examples, to estimate the dataset similarity, the WTRU may be configured to have access to two or more datasets between which the similarity has to be evaluated. The WTRU may be configured with a minimum of number of samples, Nₘᵢₙ, that the WTRU may accumulate for building its own dataset (e.g., inference dataset S_{inf}) to determine and/or evaluate dataset similarity. Additionally or alternatively, the WTRU may be configured with a maximum number of samples, Nₘₐₓ that the WTRU may accumulate. The WTRU may be configured with a first value, N1, which may represent the minimum number of samples that the WTRU accumulates and/or measures during the online operation. The WTRU may be configured with a second value, N2, which may represent the number of samples that the WTRU can utilize from one or more (e.g., any) past and/or offline measurements.

In examples, the WTRU may be configured with a dimensionality value L. L may be smaller than the true dimensionality of the data. For example, in the case of data with MIMO channels of dimensions Nt×Nr×K, where Nt may represent the transmit antennas, Nr may represent the receive antennas, and/or K may represent the number of sub-bands; value L<=Nt×Nr×K.

In examples, a WTRU may be configured with a dimensionality reduction method to reduce the dimensionality of the data before estimating the dataset similarity metric. The choice of dimensionality reduction may be based on the similarity metric, as one or more (e.g., some) dimensionality reduction methods may be best suited for one or more (e.g., some) specific dataset similarity metrics. For example, topology preserving dimensionality reduction methods (e.g., uniform manifold approximation and projection (UMAP) and/or t-distributed stochastic neighbor embedding (t-SNE) may be (e.g., best) suited for similarity metrics that are based on dataset topology. The dimensionality reduction methods may play a (e.g., significant) role in the similarity evaluation; for very large dimensional datasets, it may be interactable to calculate one or more (e.g., some) of the similarities and/or distances. For example, in the case of statistically motivated distances, which may be based on measuring the gap between two probability distributions, a first procedure may include measuring the probability distribution and/or a representation of the probability distribution from a set of data points. For high dimensional datasets, the number of datapoints required to form probability distribution and/or its representation may be (e.g., extremely) large and/or may be intractable in one or more (e.g. any) real-world settings. A WTRU may be configured to reduce the dimensionality of the data, for example, before estimating the similarity and/or distance. A WTRU may use one or more different dimensionality reduction methods. For example, a WTRU may use deep learning based methods, linear methods (e.g. principal component analysis (PCA)), feature selection methods, topology preserving dimensionality reduction, and/or the like.

In examples, a WTRU may be configured to use a deep learning-based dimensionality reduction method (e.g., an auto-encoder) to reduce the dimensionality of the data. The dimensionality of the output at the auto-encoder bottleneck layer may represent the required reduced dimensionality L. In examples, a sparsity constraint may be utilized along with the auto encoder based data compression framework.

In examples, a WTRU may be configured to use linear methods dimensionality reduction methods. For example, a WTRU may use principal component analysis (PCA) based methods for dimensionality reduction.

In examples, a WTRU may be configured to use feature selection methods to reduce the dimensionality of the data by selecting (and/or keeping) (e.g., only) a subset of the dimensions from the input data and/or disregarding the remaining subset(s) of the dimensions from the input data. In examples, the feature selection and/or dimension selection may be done by 1) ranking and/or ordering the dimensions based on their importance for a required task and/or 2) selecting the set of highest ranked features and/or dimensions. The ranking and/or ordering may be done in terms of information gain associated with each feature and/or using Shapley values.

In examples, a WTRU may be configured to use topology preserving dimensionality reduction methods. For example, a WTRU may use t-SNE method(s), which may preserve the local structure and/or topology of the data. In examples, a WTRU may be configured to use UMAP and/or pairwise controlled manifold approximation (PACMAP) approaches, which may preserve (e.g., both) local and/or global topology.

In examples, a WTRU may be configured to use a (e.g., relative) representation-based mapping using one or more (e.g., a few) anchor vectors. A WTRU and/or gNB may select a set of data points (and/or a set of points derived from the datasets, e.g., cluster the data and/or use cluster centers and/or mean vectors of the cluster as anchor vectors) as anchor points and/or a (e.g., relative) representation of the input data with respect to the anchor points may be evaluated by calculating a distance and/or similarity between a given data point, sᵢ and each of the anchor points [a₁, . . . a_{L}]. The vector and/or distances and/or similarities with respect to the anchor vector may be the lower dimensional representation.

In examples, the WTRU may be configured with a set of pre-processing methods and/or operations, which may be performed on the data before evaluating the dataset similarity. For example, the pre-processing operations may include one or more of: making the data zero mean, unit variance, scaling the data to predefined range (e.g. [−1,1]), and/or the like.

In examples, a WTRU may be configured for one or more (e.g., multiple) AIML based use cases and/or tasks (e.g. CSI compression, CSI prediction, channel estimation, beamforming, etc.). For each of the use cases, the WTRU may be configured with a set of K different AIML models {M₁, M₂, . . . , M_{K}} that may be utilized for the task.

Additionally or alternatively, for each K AIML model, the WTRU may be configured with a training dataset {D₁, D₂, . . . , D_{K}} (and/or a dataset distribution corresponding to the training data).

Embodiments described herein may include a WTRU-side determination of dataset similarity. In examples, the WTRU may use a ML based framework for a specific use case and/or task (e.g., for beamforming). Given that the WTRU is configured with K different ML models, {M₁, M₂, . . . , M_{K}}, the WTRU may activate a specific model Mᵢ for operation. The model activation may be based on configuration from the WTRU and/or based on self-determination.

In examples, during the operation/inference phase, the WTRU may collect data samples to form the data sample set and/or an inference set S_{inf}. The WTRU may measure and/or estimate the set of samples. The WTRU may (e.g., directly) receive the set of samples. For example, with respect to CSI compression, the WTRU may receive the CSI-RS from the NW and/or may measure the CSI. The WTRU may store the measured CSI samples to form the set S_{inf}.

The WTRU may collect at least a minimum required set of samples Nₘᵢₙ, and/or less than a maximum allowed set of samples Nₘₐₓ during the data collection. The WTRU may collect the set of samples during a given window of time-marked by a first starting time stamp (and/or first sample number) T1 and/or an ending time stamp (and/or last sample number) T2-such that difference between the two timestamps (e.g., T2-T1) is above a first time threshold and/or below a second time threshold.

In examples, given a set of collected data points, S_{inf}, for data set similarity evaluation, the WTR may evaluate the similarity between S_{inf} and one or more of the pre-configured data sets {D₁, D₂, . . . , D_{K}}. Considering the dataset evaluation between the set S_{inf} and the dataset associated with the (e.g., currently) active model Mᵢ the WTRU may perform one or more of the following to evaluate the similarity. The WTRU may (e.g., first) pre-process the two datasets with the configured pre-processing operations. For example, the WTRU may find the respective means associated with the two datasets and/or may subtract it from the data. In examples, the WTRU may evaluate the variance of the two datasets and/or may divide the points in the datasets by the respective variance. The WTRU may apply the configured dimensionality reduction approach to map the data to a L dimensional space. The WTRU may apply the configured dataset similarity metric to estimate the similarity between S_{inf} and Dᵢ.

In examples, the WTRU may skip (e.g., either, both of) pre-processing and/or dimensionality reduction procedures. Additionally or alternatively, the WTRU may reduce the dataset dimensionality and/or may apply the pre-processing steps.

Embodiments described herein may include a WTRU configured to report dataset similarity.

In examples, the WTRU may be configured to monitor the dataset similarity metric, for example, by collecting the data sample set, and/or comparing dataset similarity with the dataset of active model and/or one or more datasets associated with the available/supported models at the WTRU. In examples, the WTRU may be configured to monitor the dataset similarity when the WTRU is configured with a data collection configuration and/or AIML model inference configuration. In examples, the WTRU may be configured to monitor the dataset similarity when an AIML model is active. In examples, the WTRU may be configured to monitor dataset similarity when one or more of the following conditions are met: the performance of AI model goes below a threshold, the hybrid automatic repeat request (HARQ) negative acknowledgement (NACK) rate goes above a threshold, when block error rate (BLER) goes above a threshold, when a measurement (e.g., reference signal received power (RSRP), reference signal strength indicator (RSSI), reference signal received quality (RSRQ), rank indicator (RI), precoding matrix indicator (PMI), channel quality indicator (CQI), signal to interference plus noise ratio (SINR), doppler spread, doppler shift, angle of arrival (AoA), angle of departure (AoD), delay spread, average delay, position coordinates, etc.) goes below or above a threshold, upon detecting a change in configuration (e.g., bandwidth part (BWP) configuration, transmission configuration indicator (TCI) state, line of site (LOS)/non-LOS (NLOS) state, MIMO configuration etc.), upon model switch, upon a model transfer, upon model update, upon beam failure, upon RLF, upon reselection, upon mobility event, etc.

In examples, the WTRU may be configured to report the dataset similarity metric to the gNB/network. The WTRU may report the dataset similarity metric in a dedicated signaling. The WTRU may report the dataset similarity metric multiplexed with other uplink control signalling. The WTRU may report the dataset similarity metric multiplexed with signaling related to model selection/switching/activation. The WTRU may report the dataset similarity metric multiplexed with performance monitoring signaling. The WTRU may report the dataset similarity metric multiplexed with associated ID signaling.

In examples, the WTRU may transmit dataset similarity in a configured physical uplink control channel (PUCCH) resource. For example, such PUCCH resource may be configured periodically and/or semi-persistently. For example, such PUCCH resource may be indicated dynamically in a downlink control information (DCI). In example, the WTRU may transmit dataset similarity in a medium access control (MAC) control element (CE). In examples, the WTRU may be configured to trigger scheduling request (SR) to request resource for transmission of dataset similarity metric. In examples, the WTRU may be configured with a plurality of SR/PUCCH resource. Each SR resource may be associated with a dataset similarity metric range. For example, a first PUCCH resource may be (pre)configured to indicate a low dataset similarity, a second PUCCH resource may be (pre)configured to indicate a medium dataset similarity, and/or a third PUCCH resource may be (pre)configured to indicate high dataset similarity. The WTRU may (e.g., implicitly) indicate the dataset similarity metric by selection and/or transmission of SR on the (pre)configured resource. For example, if the dataset similarity metric goes below a threshold configured for low dataset similarity, the WTRU may transmit SR on the first PUCCH resource to (e.g., implicitly) indicate the dataset similarity.

In examples, the WTRU may transmit the dataset similarity metric in a radio resource control (RRC) message. For example, the WTRU may receive configuration for dataset similarity metric in a RRC reconfiguration message. The WTRU may transmit the dataset similarity metric in a RRC reconfiguration complete message. The WTRU may transmit the dataset similarity metric in a WTRU Assistance Information message. The WTRU may receive dataset similarity metric configuration in a WTRU information request message. The WTRU may transmit the dataset similarity metric in WTRU information response message.

Embodiments described herein may include dataset similarity-based model switching.

As a function of dataset similarity, for example, a WTRU may be configured to perform one or more of: model selection, model switching, model activation, model deactivation, and/or model monitoring. For example, the WTRU may derive the similarity metric based on one or more methods (e.g., as described herein).

The WTRU may be configured with one or more use cases (e.g., CSI compression, CSI prediction, channel estimation, beam management, positioning, etc.) for AIML based operation. The WTRU may be configured with a plurality of (e.g., reference) datasets {D₁, D₂, . . . , D_{K}}, which may be generated based on one or more of the following methods: WTRU measurements, statistical methods, ray tracing methods, field measurements, generative models, logged measurements, digital twins, and/or the like. The WTRU may be configured with a set of K AI models {M₁, M₂, . . . , M_{K}} for each use case. In examples, the terms AI model and functionality may be used interchangeably. Functionality may include one or more AI models.

The WTRU may collect one or more data samples to form data sample set S_{inf} (e.g., based on WTRU measurement(s)), such that they meet one or more of the following conditions: the time difference between the first and last sample in the data sample set is above a first threshold and/or below a second threshold; the size of the data sample set is above a preconfigured value N (e.g., minimum number of samples and a max number of samples); at least x % of the data sample set meets a preconfigured quality criteria (e.g. the quality criteria may be expressed as different conditions, for example, SNR, WTRU location, etc.); and/or the measurements samples with the data sample set may be associated with same network side conditions (e.g., same associated ID).

The WTRU may derive dataset similarity between data sample set S_{inf} and one or more of the reference datasets {D₁, D₂, . . . , D_{K}}. For example, the WTRU may derive the dataset similarity metric based on one or more methods described herein. In examples, as a function of dataset similarity, the WTRU may be configured to perform one or more of: model selection, model activation and/or model deactivation, model switching, model monitoring, fallback, and/or the like.

The WTRU may be configured with a first threshold (e.g., Threshold1) and/or a second threshold (e.g., Threshold2). For example, the second threshold may be lower than the first threshold. The WTRU may be configured with a set of K AI models M₁, M₂, . . . , M_{K} for each use case. Each model may be associated (and/or trained) with datasets D₁, D₂, . . . , D_{K}, respectively.

The WTRU may be configured to determine and/or monitor the dataset similarity metric based on one or more trigger conditions (e.g., as described herein). The WTRU may be configured to determine the dataset similarity between S_{inf} and the dataset Da associated with the currently active model Ma. If the dataset similarity is below a first threshold, for example, the WTRU may determine dataset similarity between the S_{inf} and the remaining datasets {D₁, D₂, . . . , D_{K}}. Dataset Da may be associated with the highest similarity. In examples, if the highest similarity is above a first threshold, the WTRU may switch to the model Mₛ corresponding to the dataset Dᵢ with the highest similarity to the set S_{inf}. The WTRU may transmit a report to the network indicating the model switch. The report may include one or more of the following information: the model ID of the other (e.g., new) model, a dataset similarity metric, one or more statistics related to dataset similarity metric of other model(s), and/or the like. In examples, if the highest similarity is above the first threshold, the WTRU may indicate to the network the model ID of the model Mₛ corresponding to the dataset Dᵢ with the highest similarity to the set S_{inf}. The WTRU may include additional information in the report, such as the highest dataset similarity metric, statistic related dataset similarity metric of other models etc.

If the highest dataset similarity is below a second threshold, for example, the WTRU may deactivate AIML operation and/or may fallback to another (e.g., legacy) procedure. For example, the WTRU may deactivate the AI model associated with CSI compression and/or may fallback to another (e.g., legacy) CSI reporting. In examples, if the highest dataset similarity is below a second threshold, the WTRU may request additional model transfer and/or dataset transfer. For example, the WTRU may send a message to the network based on a determination that none of the configured K models have a similarity value above a threshold. The message may include an indication that indicates a request for one or more additional models (and/or corresponding dataset(s). The WTRU may transmit a report to the network indicating the fallback. The report may include one or more of the following information: highest dataset similarity metric, one or more statistics related dataset similarity metric of other model(s), and/or the like.

In examples, the WTRU may be configured to report, based on a condition associated with the dataset similarity, the data samples S_{inf} to the network. The WTRU may transmit a statistic (e.g., minimum, maximum, average, standard deviation, etc.) associated with data samples S_{inf}. The WTRU may transmit a low dimensional transformation of the data samples. The WTRU may transmit a low processed/quantized/compressed version of the data samples. For example, the WTRU may transmit the data samples when the dataset similarity between S_{inf} and the Da of the active model is below a threshold. The WTRU may transmit the data samples when the dataset similarity between S_{inf} and the Dᵢ associated with one or more (e.g, any) available models is above a threshold. The WTRU may be configured to transmit (e.g., periodically, semi-persistently, aperiodically, based on event(s), and/or based on a network request) one or more of: a dataset similarity metric, one or more data samples, a model ID, model selection/switching information, one or more (e.g., any) WTRU side condition (e.g., RSRP, RSSI, RSRQ, RI, PMI, CQI, SINR, doppler spread, doppler shift, AoA, AoD, delay spread, average delay, position coordinates etc.), and/or the like.

Embodiments described herein may include dataset similarity based performance monitoring.

A WTRU may be configured with one or more performance metrics for the determination of the similarity and/or distance between training and inference dataset(s), for performance monitoring of an AIML model. In examples, the WTRU may evaluate one or more (e.g., multiple) performance estimates (e.g., P1, P2, P3, . . . ) based on dataset similarity and/or distances, for example, using one or more performance metric(s).

For example, a performance estimate metric P1 may be based on a WTRU/BS joint similarity evaluation. In examples, a WTRU may evaluate similarity between Dᵢ and S_{inf}, where the WTRU may report the calculated similarity. With respect to \ data compression use case with two-sided autoencoder based models (e.g., CSI compression), for example, the WTRU may share information about the samples in S_{inf} (e.g., first-order statistics), and/or the window start and/or end indices used to evaluate S_{inf}. The WTRU may request dataset similarity between Dᵢ and the reconstructed samples at the network side corresponding to S_{inf}. In examples, the WTRU may determine a difference metric between WTRU determined similarity and network determined similarity, to calculate a performance metric

$$( e . g . , P 1 = 1 - \frac{{Similarity}_{UE} - {Similarity}_{BS}}{{Similarity}_{UE}} ) .$$

In examples, one or more (e.g., multiple) performance metrics may be configured by the network for each performance estimate.

In examples, a performance estimate metric P2 may be based on a (pre) defined mapping (e.g., performance curves). A WTRU may be pre-configured (e.g., via RRC) by one or more metrics to use in a configured mapping function. The WTRU may be configured dynamically (e.g., via DCI and/or MAC-CE) with a mapping function and/or its associated one or more metrics, for a given performance estimate. In examples, a WTRU may evaluate dataset similarity between Dᵢ and S_{inf}, and/or may utilize the configured performance curve(s) to estimate the performance of the model (e.g., directly) from the dataset similarity and/or distances measurement(s). A WTRU may determine a performance metric P2 as a function of the estimated AIML model performance. An example of a performance metric P2 may be

$$P 2 = \frac{PCurve ( {Similarity}_{UE} )}{c 2} ,$$

where c2 may be a scaling and/or normalizing factor; c2 can be pre-configured with the associated performance estimate P2 configuration, and/or may be autonomously defined by the WTRU. The term c2 may be determined (e.g., by a WTRU), for example, based on one or more of a maximum value of the performance curve, variance of the performance curve, and/or the like.

In examples, a performance estimate metric P3 may be based on the detection of out of distribution (OOD) samples and/or data point with respect to the dataset Dᵢ. For example, a WTRU may employ a pointwise similarity (e.g., geometric distance) to evaluate the similarity between a data point (sample) and the dataset Dᵢ. In examples, OOD detection may be performed by the determination of a OOD score and/or indicator. For example, the WTRU may perform OOD detection. In examples, OOD detection may be performed using a specific AIML model for OOD classification. In examples, a WTRU may be configured to determine a OOD score based on the combination of one or more (e.g., multiple) calculations and/or methods. A WTRU may use the OOD-based similarity and/or distance to determine a performance estimate metric P3, e.g.,

$$P 3 = \frac{{Similarity}_{UE}}{c 3} ,$$

where c3 may be a scaling/normalizing factor.

A WTRU may determine a performance estimate of an AIML model as a function of a combination of the determined performance estimate metrics (e.g., as described herein). In examples, the WTRU may be configured with a set of thresholds associated to each configured performance estimate metric. In examples, the WTRU may determine a binary indicator for each performance estimate metric based on whether the determined performance estimate metric is above or below the associated threshold. The WTRU may determine an estimate of the performance of the model based on the summation of the determined binary indicator(s) (e.g., the performance can be represented by an integer score indicating the performance estimate score).

In examples, the WTRU may be configured with a weighted combination function based on (pre)configured weight(s) (e.g., relevance and/or importance weights) associated with each configured performance estimate metric. For example, Performance=w1 P1+w2P2+w3P3. In examples, the weights can be configured based on the importance of each performance estimate metric. In examples, the weights can be statically configured (e.g., via RRC) for each AIML model. In examples, the weights can be dynamically configured (e.g., via DCI and/or MAC-CE), for example, based on a long-term (e.g., historical) performance estimate of a AIML model; the relevance of each configured performance estimate metric can be (e.g., dynamically) controlled and/or adapted by the network.

A WTRU may report the determined estimate performance to the network periodically (e.g., at a performance monitoring cadence), semi-persistently (e.g., periodically across a configured performance monitoring window), and/or based on a trigger (e.g., when the performance drops below a (pre)-defined threshold). The estimated performance report may be carried out via PUCCH (e.g. via uplink control information (UCI)), and/or via physical uplink shared channel (PUSCH) (e.g., when the payload size is above a threshold). For example, the performance report may be carried out via PUSCH for a joint report in CSI compression use-case when the determined estimated performance is transmitted jointly with the compressed CSI, and/or when one or more (e.g., multiple) compressed samples are transmitted jointly with their associated estimated performance.

Embodiments described herein may include dataset similarity based associate ID management.

A WTRU may be configured with different datasets, with different (e.g., AI/ML) models trained on the different datasets. The associated ID may be a unique number and/or alphanumeric identifier corresponding to the stored datasets. Each dataset, corresponding to a different associated ID, may be collected using different channel and/or operating conditions. The performance of an (e.g., AI/ML) model trained on the dataset with a particular training associated ID may be affected when the data at inference time drifts with respect to the trained dataset. Embodiments described herein may include (e.g., seamless) operation at the WTRU, which may include monitoring and/or updating dataset(s) with each associated ID. Based on the amount of drift observed, for example, a dataset (e.g., associated with a different ID) may be updated. Based on the amount of drift observed, another (e.g., new) dataset with another (e.g., new) associated ID may be created. The dataset similarity metric may be used to quantitatively evaluate this dataset drift.

A WTRU may be configured with different associate IDs {ID₁, ID₂ . . . . ID_{K}} and/or the corresponding datasets {DA₁, . . . . DA_{K}}. There may be K different models {M₁, M₂, . . . , M_{K}}, trained on the K datasets.

The WTRU may receive an activation indication for one of its configured ML models, for example Mᵢ. In examples, the active model Mᵢ may be associated with the training dataset DAᵢ and/or the active associated ID, IDᵢ.

The WTRU may be configured to measure the similarity (and/or the drift) between a first dataset (e.g., the training dataset for the active model) and a second dataset (e.g., current/inference dataset). The configuration may include one or more of the following. The configuration may include configuration of a similarity metric type and/or a set of similarity metrics type. The similarity metric type may include geometric distances, statistical distances, manifold distances, and/or the like. The configuration may include of a threshold and/or a set of thresholds corresponding to the similarity metric type, for example, to determine whether the drift and/or the dis-similarity between the first and second datasets may result in model performance degradation. For example, when the WTRU is configured to use geometric distance as similarity metric type, the WTRU may receive configuration for a threshold geometric distance between datasets below which the model performance degrades. In examples, when the WTRU is configured with geometric distance and/or statistical distance as similarity metrics type, the WTRU may receive configuration of a geometric distance threshold and/or configuration of a statistical distance threshold.

A WTRU may evaluate dataset similarity based on one or more methods (e.g., as described herein).

A WTRU may use geometric distances to evaluate dataset similarity. Geometric distances may include pairwise Euclidian, centroid wise Euclidian, cosine, and/or the like. In this class of similarity metrics, the dataset similarity may be evaluated using the individual samples of the distribution. A pairwise Euclidian distance may be calculated by measuring the distance between each combination of pairs of samples {sₖ,ŝₗ}, sₖ∈S_{inf}, ŝₗ∈DAᵢ. A metric to use may include the I2-nom, expressed as dₖₗ=∥sₖ−ŝₗ∥₂. A matrix of size N_{DA}_{ᵢ}×N_{S}_{_{inf}} may be created to evaluate the different pairwise differences for one or more of (e.g., all of) the corresponding samples in (e.g., both of) the datasets. Additionally or alternatively, a centroid-based distance may be used. The dataset centroid may be evaluated as

$${c}_{{DA}_{i}} = \frac{1}{{N}_{{DA}_{i}}} {\sum }_{{s}_{k} ∈ {DA}_{i}} {s}_{k} ( \text{and/or} correspondingly {c}_{{S}_{inf}} for {S}_{inf} ) .$$

The I2-norm Euclidian distance may be calculated for the centroids of the two datasets. Another geometric distance that can be used may be the cosine similarity given by the form

$${d}_{kl} = \frac{{s}_{k}^{T} {s}_{l}}{‖ {s}_{k} ‖ ‖ {s}_{l} ‖} .$$

The cosine similarity can be evaluated on a per-sample basis and/or using the dataset centroid.

A WTRU may use statistical distances to evaluate dataset similarity. Statistical distances may include one or more of KL divergence, Jensen Shannon, Wasserstein, Hellinger, and/or Total variation. In this class of methods, the distribution of the dataset may be used to evaluate the dataset similarity. In the absence of closed form and/or analytical expressions for the distribution of the dataset, empirical methods can be used calculate the distribution. A method may include the use of a histogram of the dataset sample values. ƒ_{DA}_{ᵢ}(x) may represent the analytically evaluated distribution (e.g., over the domain [symbol] ). ƒ_{S}_{_{inf}}(x) may be represent the empirically evaluated distribution (e.g., over the domain [symbol] ). Based on ƒ_{DA}_{ᵢ}(x) and/or ƒ_{S}_{_{inf}}(x), one or more of the dataset similarity metrics may be given as described herein.

For example, the KL divergence between two distributions may be evaluated as:

$${D}_{KL} ( {f}_{{DA}_{i}} ‖ {f}_{{s}_{inf}} ) = {\sum }_{x ∈ {𝒟}_{x}} {f}_{{DA}_{i}} ( x ) log \frac{{f}_{{DA}_{i}} ( x )}{{f}_{{S}_{inf}} ( x )} \qquad Equation ( 3 )$$

For example, the Jensen-Shannon divergence may use the KL divergence with additional smoothening. This may be given by the form:

$$JSD ( {f}_{{DA}_{i}} ‖ {f}_{{S}_{inf}} ) = \frac{1}{2} {D}_{KL} ( {f}_{{DA}_{i}} ‖ M ) + \frac{1}{2} {D}_{KL} ( {f}_{{S}_{inf}} ‖ M ) \qquad Equation ( 4 )$$

$$M = \frac{1}{2} ( {f}_{{DA}_{i}} + {f}_{{S}_{inf}} ) may represent the mixture distribution .$$

The total variation distance may measure the absolute difference between the probabilities given by the two distributions, summed over the (e.g., entire) domain. Total variation distance may be given by the expression:

$$TVD ( {f}_{{DA}_{i}} , {f}_{{S}_{inf}} ) = \frac{1}{2} {\sum }_{x ∈ {𝒟}_{x}} \vert {f}_{{DA}_{i}} ( x ) - {f}_{{S}_{inf}} ( x ) \vert \qquad Equation ( 5 )$$

Wasserstein distance metric may measure the cost of transforming one of the distribution to another (e.g., by moving mass from one distribution to another). Wasserstein distance metric may be expressed as:

$$W ( {f}_{{DA}_{i}} , {f}_{{S}_{inf}} ) = {( {\sum }_{{x}_{k} , {x}_{l} ∈ {𝒟}_{x}} {d ( {x}_{k} , {x}_{l} )}^{p} {γ}_{kl} )}^{\frac{1}{p}} \qquad Equation ( 6 )$$

The term p may represent the order of the Wasserstein distance, d(⋅) may represent the distance between the samples, and/or γ_{k,l} may represent the (e.g., optimal) transportation plan (e.g., evaluated using separate optimization process). There may be specific optimization packages in one or more (e.g., all) of the standard numerical solvers that evaluate the Wasserstein distance in a numerical manner.

The Hellinger distance metric may include another similarity metric that is limited to the domain (0,1) to evaluate the dataset similarity between two distributions. The Hellinger distance metric may be (e.g., more) robust to small changes in distribution (e.g., compared to KL divergence). The Hellinger distance metric may be expressed as:

$$H ( {f}_{{DA}_{i} , {S}_{inf}} , {f}_{{S}_{inf}} ) = \frac{1}{\sqrt{2}} \sqrt{{\sum }_{x ∈ {D}_{x}} {( \sqrt{{f}_{{DA}_{i}} ( x )} - \sqrt{{f}_{{S}_{inf}} ( x )} )}^{2}} \qquad Equation ( 7 )$$

Manifold distances (e.g., Grassman, chordal) methods may be used to evaluate the similarity between the datasets using the underlying geometric structure of the data samples. Grassman distance may be computed for the subspaces of the underlying distribution. The Grassmann distance may be a measure of the distance between two subspaces on the Grassmann manifold. The Grassmann manifold may be the space of one or more (e.g., all) p-dimensional subspaces of an n-dimensional vector space. This form of evaluation of the dataset manifolds may imply that it cannot be calculated for discrete distributions (e.g., discrete distributions empirically evaluated using a histogram). The Grassmann distance can be calculated if there exists an underlying closed form expression in the continuous valued space for the datasets to be compared. The Chordal distance may be based on using the underlying continuous-valued distribution to evaluate the expression of the manifold. The chordal distance may be used to evaluate similarity between distributions by considering their representations on a spherical manifold.

The WTRU may collect data samples to form data sample set S_{inf}, for example, through WTRU-side measurements and/or through offline data generation methods (e.g., using a generative model to create the data samples). The WTRU may evaluate the configured metric (and/or set of metrics) to determine the dataset similarity between the actively collected samples in S_{inf} and the stored dataset DAᵢ with the corresponding active associated ID, IDᵢ.

A WTRU may produce and/or report one or more similarity metrics and/or associated ID(s). The WTRU may measure the configured similarity metric (and/or set of metrics) between a first dataset (e.g., a training dataset, DAᵢ) and a second dataset (e.g., the inference dataset S_{inf}).

If the WTRU determines that the measured similarity metric is greater than a configured threshold (e.g., the datasets are similar), for example, the WTRU may report the measured similarity metric. Such reporting may be performed periodically, at predefined monitoring windows and/or time stamps, and/or may be performed as a response to a model monitoring request from the network.

If the WTRU determines that the measured similarity metric is less than a configured threshold (e.g., the first and second datasets are dis-similar), for example, the WTRU may perform one or more of the following.

If the WTRU determines that the measured similarity metric is less than a configured threshold (e.g., the first and second datasets are dis-similar), for example, the WTRU may report the measured similarity metric for the active associated ID. The WTRU may measure and/or may report to the network other similarity metrics types, for example, to provide additional information on extent of dataset drift, specific sensitivity to outliers, and/or the like.

If the WTRU determines that the measured similarity metric is less than a configured threshold (e.g., the first and second datasets are dis-similar), for example, the WTRU may measure the similarity metric between the second dataset (e.g., the inference dataset S_{inf}) and one or more of the datasets corresponding to configured but inactive models (e.g., DAₖ, where k≠i). In examples, the WTRU may report the list of measured similarity metrics, and/or the corresponding associated IDs. In examples, the WTRU may report the highest similarity metric and the corresponding associated ID. This may be performed if the similarity value exceeds the pre-configured threshold. For example, the WTRU may perform a model switch and/or send a model switch request to the network when the highest similarity metric exceeds the configured threshold.

If the WTRU determines that the measured similarity metric is less than a configured threshold (e.g., the first and second datasets are dis-similar) and if none of the configured associate IDs and/or their corresponding datasets have a similarity, to the inference dataset S_{inf}, above a (pre) defined and/or (pre)configured threshold, the WTRU may request from the network another (e.g., new) dataset with another (e.g., new) associated ID. When the WTRU receives the other (e.g., new) dataset and/or the other (e.g., new) associated ID from the network, for example, the WTRU may measure the similarity metric between the other (e.g., new) dataset and the inference dataset S_{inf}; the WTRU may use the other (e.g., new) dataset for retraining and/or fine tuning the active (e.g., AIML) model, for example, if the similarity metric exceeds the configured threshold. In examples, the WTRU may update its list(s) of supported models {M₁, M₂, . . . , M_{K},}, corresponding datasets {DA₁, . . . . DA_{K},}, and/or associate IDs {ID₁, ID₂, . . . ID_{K},}

If the WTRU determines that the measured similarity metric is less than a configured threshold (e.g., the first and second datasets are dis-similar) and if none of the configured associate IDs and/or their corresponding datasets have a similarity, to the inference dataset S_{inf}, above a (pre) defined and/or (pre)configured threshold, the WTRU may determine whether the data drift is due to a change in the WTRU-side (e.g., additional) conditions (e.g., WTRU speed). When the WTRU determines that the data drift is due to a change in the WTRU-side (e.g., additional conditions), for example, the WTRU may send an indication to the network and/or a request for another (e.g., new) associated ID. When the WTRU receives another (e.g., new) associated ID, for example, the WTRU may collect (e.g., store and/or report) a dataset that includes the current data samples in S_{inf}. The WTRU may (e.g., further) fine-tune the active model using the (e.g., newly) collected dataset, that corresponds to the other (e.g., new) associated ID received from the network. The WTRU may (e.g., further) report the (e.g., newly) collected dataset to the network to associate the other (e.g., new) associate ID with the corresponding dataset.

When the active ML model, e.g., Mᵢ was trained on a mixed dataset, for example the union of component datasets {DAᵢ₁, . . . . DA_{iN}}, the WTRU may measure a similarity metric between the second dataset (e.g., the inference dataset S_{inf}) and each component dataset {DAᵢ₁, . . . . DA_{iN}}. The WTRU may determine that the training mixed dataset and the inference dataset are dis-similar, for example, when the measured similarity metric for each component dataset is below a configured threshold.

A WTRU may receive configuration information. The configuration information may include dataset similarity configuration information. The WTRU may be configured with a plurality of artificial intelligence machine learning (AIML) models and/or training information (e.g., one or more training data sets) associated with each AIML model of the plurality of AIML models. The WTRU may generate a data sample set based on the dataset similarity configuration information. The WTRU may determine a dataset similarity value for the (e.g., first AIML) model based on the dataset similarity configuration information, the data sample set, and/or the training data set associated with the (e.g., first) AIML model. The dataset similarity value may indicate a similarity between the training data set associated with each (e.g., the first) AIML model and the data sample set. The WTRU send an indication to a base station. The indication may indicate the first dataset similarity value and/or a preferred AIML model (e.g., of the plurality of AIML models).

A WTRU may receive configuration information. The configuration information may include dataset similarity configuration information. The WTRU may be configured with a plurality of training data sets and/or an AIML model. The WTRU may generate a data sample set associated with the AIML model. The WTRU may determine a dataset similarity value for the AIML model based on the dataset similarity configuration information, the plurality of training data sets, and/or the data sample set. The dataset similarity value may indicate a similarity between the plurality of training data sets associated with the AIML model and the data sample set. The WTRU may send an indication to a base station. The indication may indicate the dataset similarity value and/or a preferred AIML model.

A WTRU may receive configuration information. The configuration information may include dataset similarity configuration information. The WTRU may be configured with a plurality of training data sets and/or a plurality of AIML models. The WTRU may generate a data sample set associated with the plurality of AIML models. The WTRU may determine a dataset similarity value for each AIML model based on the dataset similarity configuration information, the plurality of training data sets, and/or the data sample set. The dataset similarity value may indicate a similarity between the plurality of training data sets associated with each AIML model of the plurality of AIML models and the data sample set. The WTRU may send an indication to a base station. The indication may indicate the dataset similarity value and/or a preferred AIML model (e.g., of the plurality of AIML models).

1. A wireless transmit/receive unit (WTRU) comprising:
a processor configured to:
receive configuration information, wherein the configuration information comprises dataset similarity configuration information, wherein the WTRU is configured with a plurality of artificial intelligence machine learning (AIML) models and a training data set associated with each AIML model of the plurality of AIML models;
generate a data sample set based on the dataset similarity configuration information;
determine a first dataset similarity value for a first AIML model of the plurality of AIML models, wherein the first dataset similarity value is determined based on the dataset similarity configuration information, the data sample set, and the training data set associated with the first AIML model, wherein the dataset similarity value for the training data set indicates a similarity between the training data set associated with the first AIML model and the data sample set; and
send an indication to a base station, wherein the indication indicates the first dataset similarity value and a preferred AIML model of the plurality of AIML models.

2. The WTRU of claim 1, wherein the processor is configured to:
determine that the first dataset similarity value for the first AIML model is below a threshold;
determine a second dataset similarity value for a second AIML model of the plurality of AIML models based on the dataset similarity configuration information, the data sample set, and the training data set associated with the second AIML model; and
determine that the second dataset similarity value is above the threshold, wherein the preferred AIML model indicated by the indication is the second AIML model.

3. The WTRU of claim 1, wherein the processor is configured to:
determine that the first dataset similarity value for the first AIML model is below a threshold;
determine a second dataset similarity value for a second AIML model of the plurality of AIML models based on the dataset similarity configuration information, the data sample set, and the training data set associated with the second AIML model;
determine that the second dataset similarity value is above the threshold; and
activate the second AIML model based on the second dataset similarity value being above the threshold.

4. The WTRU of claim 1, wherein the processor is configured to:
determine that the first dataset similarity value for the first AIML model is below a threshold;
determine a second dataset similarity value for a second AIML model of the plurality of AIML models based on the dataset similarity configuration information, the data sample set, and the training data set associated with the second AIML model;
determine that the second dataset similarity value is below a second threshold; and
fallback to legacy operation or send a request to the base station for additional an AIML model.

5. The WTRU of claim 1, wherein the processor is configured to compare the data sample set to the training data set of the first AIML model to determine the first dataset similarity value.

6. The WTRU of claim 1, wherein the dataset similarity configuration information comprises one or more of: a similarity metric, one or more thresholds, performance prediction curves, and wherein the processor is configured to determine the first dataset similarity value based on the similarity metric, the one or more thresholds, or the performance prediction curves.

7. The WTRU of claim 1, wherein the processor is configured to determine the first similarity metric using one or more of a geometric-based distance, a statistical-based distance, or a manifold-based metric;
wherein the geometric-based distance comprises one or more of a pairwise Euclidean-based metric, a centroid wise Euclidean-based metric, a cluster wise Euclidean-based metric, a cosine-based metric;
wherein the statistical-based distance comprises one or more of a kullback-leiber divergence-based metric, a Jensen Shannon-based metric, a Wasserstein-based metric, a Hellinger-based metric, or a total variation-based metric; and
wherein the manifold metric comprises one or more of a Grassmann-based metric or a chordal-based metric.

8. The WTRU of claim 1, wherein the dataset similarity configuration information comprises a lower dimensional space value, and wherein processor is configured to use a dimensionality reduction method to determine, based on the lower dimensional space value, a reduced dataset dimensionality of the data sample set and a reduced dimensionality of the training data set associated with the first AIML model, and wherein the first dataset similarity value is determined based on the reduced dataset dimensionality of the data sample set and the reduced dimensionality of the training data set associated with the first AIML model.

9. The WTRU of claim 1, wherein the dataset similarity configuration information comprises an indication that indicates a minimum number of data samples and a period of time, and wherein the processor is configured to generate the data sample set based on the minimum number of data samples or the period of time.

10. The WTRU of claim 1, when the first dataset similarity value is less than a threshold, the processor is configured to send a message to a base station, wherein the message comprises an indication that indicates a request for one or more additional AIML models or corresponding datasets, and
wherein the processor is configured to use the first AIML model to perform one or more of: channel state information (CSI) compression, CSI prediction, channel estimation, or beam management.

11. A method performed by a wireless transmit/receive unit (WTRU), the method comprising:
receiving configuration information, wherein the configuration information comprises dataset similarity configuration information, wherein the WTRU is configured with a plurality of artificial intelligence machine learning (AIML) models and a training data set associated with each AIML model of the plurality of AIML models;
generating a data sample set based on the dataset similarity configuration information;
determining a first dataset similarity value for a first AIML model of the plurality of AIML models, wherein the first dataset similarity value is determined based on the dataset similarity configuration information, the data sample set, and the training data set associated with the first AIML model, wherein the dataset similarity value for the training data set indicates a similarity between the training data set associated with the first AIML model and the data sample set; and
sending an indication to a base station, wherein the indication indicates the first dataset similarity value and a preferred AIML model of the plurality of AIML models.

12. The method of claim 11, further comprising:
determining that the first dataset similarity value for the first AIML model is below a threshold;
determining a second dataset similarity value for a second AIML model of the plurality of AIML models based on the dataset similarity configuration information, the data sample set, and the training data set associated with the second AIML model; and
determining that the second dataset similarity value is above the threshold, wherein the preferred AIML model indicated by the indication is the second AIML model.

13. The method of claim 11, further comprising:
determining that the first dataset similarity value for the first AIML model is below a threshold;
determining a second dataset similarity value for a second AIML model of the plurality of AIML models based on the dataset similarity configuration information, the data sample set, and the training data set associated with the second AIML model;
determining that the second dataset similarity value is above the threshold; and
activating the second AIML model based on the second dataset similarity value being above the threshold.

14. The method of claim 11, further comprising:
determining that the first dataset similarity value for the first AIML model is below a threshold;
determining a second dataset similarity value for a second AIML model of the plurality of AIML models based on the dataset similarity configuration information, the data sample set, and the training data set associated with the second AIML model;
determining that the second dataset similarity value is below a second threshold; and
falling back to legacy operation or send a request to the base station for additional an AIML model.

15. The method of claim 11, wherein the determining the first dataset similarity value comprises comparing the data sample set to the training data set of the first AIML model.

16. The method of claim 11, wherein the dataset similarity configuration information comprises one or more of: a similarity metric, one or more thresholds, performance prediction curves, and wherein the method further comprising determining the first dataset similarity value based on the similarity metric, the one or more thresholds, or the performance prediction curves.

17. The method of claim 11, further comprising determining the first similarity metric using one or more of a geometric-based distance, a statistical-based distance, or a manifold-based metric;
wherein the geometric-based distance comprises one or more of a pairwise Euclidean-based metric, a centroid wise Euclidean-based metric, a cluster wise Euclidean-based metric, a cosine-based metric;
wherein the statistical-based distance comprises one or more of a kullback-leiber divergence-based metric, a Jensen Shannon-based metric, a Wasserstein-based metric, a Hellinger-based metric, or a total variation-based metric; and
wherein the manifold metric comprises one or more of a Grassmann-based metric or a chordal-based metric.

18. The method of claim 11, wherein the dataset similarity configuration information comprises a lower dimensional space value, and wherein method further comprising using a dimensionality reduction method to determine, based on the lower dimensional space value, a reduced dataset dimensionality of the data sample set and a reduced dimensionality of the training data set associated with the first AIML model, and wherein the first dataset similarity value is determined based on the reduced dataset dimensionality of the data sample set and the reduced dimensionality of the training data set associated with the first AIML model.

19. The method of claim 11, wherein the dataset similarity configuration information comprises an indication that indicates a minimum number of data samples and a period of time, and wherein the method further comprising generating the data sample set based on the minimum number of data samples or the period of time.

20. The method of claim 11, when the first dataset similarity value is less than a threshold, the method further comprising sending a message to a base station, wherein the message comprises an indication that indicates a request for one or more additional AIML models or corresponding datasets, and
wherein the method further comprising using the first AIML model to perform one or more of: channel state information (CSI) compression, CSI prediction, channel estimation, or beam management.
